(19) United States
(12) Patent Application Publication
(10) Pub. No.: US 2014/0201058 A1
(43) Pub. Date: Jul. 17, 2014

(54) Stewardship Method for Managing Ozone-Depleting Substances

(71) Applicant: EOS Climate, San Francisco, CA (US)

(72) Inventor: Saskia Feast, San Rafael, CA (US)

(73) Assignee: EOS Climate, San Francisco, CA (US)

(21) Appl. No.: 14/155,586

(22) Filed: Jan. 15, 2014

Related U.S. Application Data
(60) Provisional application No. 61/752,636, filed on Jan. 15, 2013.

(51) Int. Cl. G06Q 40/04; G06Q 30/00

(52) U.S. Cl. CPC G06Q 40/04; G06Q 30/018
USPC 705/37

(57) ABSTRACT

A stewardship system integrates the management of ozone depleting substances and halogenated substances, such as chlorofluorocarbons (CFC), across multiple players in the supply chain, carbon credit generation, sale of carbon credits within the various carbon credit markets, and improves distribution of the profits to the contributing entities. A central processing entity mediates transactions between the different entities.

### RELATED APPLICATIONS

This patent application claims the benefit of priority to U.S. Provisional Patent Application Ser. No. 61/752,636, entitled “Stewardship Method for Managing Ozone-Depleting Substances” filed on Jan. 15, 2013, the entire contents of which are hereby incorporated by reference.

### FIELD OF THE INVENTION

This application relates in general to methods and systems for managing carbon credits by providing an interface between customers using ozone-depleting substances, including CFCs, and other fluorinated refrigerants, companies that offer services and technology to track and destroy such substances, and the ability to derive value from the destruction in the form of tradable carbon credits.

### BACKGROUND

Carbon credits have come into use as financial derivatives to encourage the reduction of emissions of greenhouse gases such as carbon dioxide (CO₂) into the atmosphere. Property owners who can show verifiable reduction in CO₂ emissions or other GHG emissions (CO₂e), or who show verifiable destruction of ozone-depleting substances (ODS) can qualify for carbon credits. Markets have formed to trade such emissions reductions as commodities among buyers and sellers.

One of the goals of the carbon trading market goal is to allow market mechanisms to set a fair price on carbon, thus driving industrial and commercial processes in the direction of low emissions or less carbon-intensive approaches. While there are companies that sell assist other customers in lowering their carbon footprints, a system is needed that integrates the various parties in the use of refrigerants, the creation of carbon credits from the destruction of eligible refrigerants, and trading in which credits can be sold and traced across the market from the source to the customer.

### SUMMARY

The various embodiments provide a method for managing destruction of ozone-depleting or halogenated substances (ODS), including: providing the ozone-depleting or halogenated substance from a plurality of customers to a destruction process, in which the destruction of the substance creates carbon credits; selling at least a first portion of the carbon credits on a carbon credit market; receiving proceeds from the sale of the carbon credits; and sharing the proceeds from the sale of the carbon credits with at least one participant in the destruction process, where the value of carbon credits per unit of the ozone-depleting or halogenated substance destroyed from different customers of the plurality of customers have different values per unit of the substance destroyed.

In an embodiment, the ozone-depleting or halogenated substance is a man-made halogenated ozone-depleting substance (ODS). In an embodiment, the ozone-depleting or halogenated substance is a chlorofluorocarbon (CFC), hydro chlorofluorocarbon (CHIC), or hydro fluorocarbon (HUFF). Another embodiment includes verifying a result from destruction of the ozone-depleting or halogenated substance. Another embodiment includes verifying the process for destruction of the ozone-depleting or halogenated substance for compliance with standards maintained by the carbon credit market. In another embodiment, the at least one customer is a developing country, and at least one purchaser of the carbon credits on the carbon credit market is a developed country.

### BRIEF DESCRIPTION OF THE DRAWINGS

The accompanying drawings, which are incorporated herein and constitute part of this specification, illustrate exemplary aspects of the invention. Together with the general description given above and the detailed description given below, the drawings serve to explain features of the invention.

FIG. 1 illustrates a schematic diagram of an ODS management system according to an embodiment.

FIG. 2 illustrates a schematic diagram of an ODS management system according to an embodiment.

FIG. 3 is a schematic diagram of a global ODS management system according to an embodiment.

FIG. 4 is a process flow diagram illustrating an ODS management method according to an embodiment.

FIG. 5 is a component block diagram of a laptop computer suitable for implementing the various embodiment methods.

FIG. 6 is a component block diagram of a server suitable for implementing the various embodiment methods.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the invention or the claims.

As used herein, “ODS” refers to ozone depleting substances, such as chlorofluorocarbons (CFCs) and other halogenated man-made chemicals. While the various embodiments herein reference CFC management, such reference merely serves as an example and not to limit the applicability of the methods and systems to other halogenated man-made chemicals.

As used herein, “green house gas” or “GHG” refers to a gas in the atmosphere that absorbs and emits radiation within the thermal infrared range, thereby contributing to the greenhouse effect.

Environmental markets have developed worldwide, addressing needs of voluntary and regulation-mandated companies for GHG emissions reduction.

Offsets programs exist that ensure the environmental integrity of GHG emissions reduction projects and to create value in the carbon market in the form of offset credits. For example, the Climate Action Reserve (“Reserve”) provides protocols for project development and the quantification of carbon offset credits. GHG reduction projects are verified by an independent third party as adhering to criteria established in the protocols approved by the Reserve.

In particular, one project type is ODS destruction, wherein the collection, purification, analysis, and destruction of eligible ODS can be quantified and verified against the protocol leading to high quality emission reductions.

In the various embodiments, a system is created that efficiently manages ODS in order to create value, for example in the form of trade carbon credits. In the various embodiments, the system is maintained by a Central Processing Entity. The Central Processing Entity, which may be one or multiple servers, may be configured with connections to the Internet and to other communication networks to enable computer-to-computer communications, computer displays coupled to the servers to support a human operator, and/or telephones sufficient to enable one or more individuals to effect the coordination of the various steps in ODS management.

In a preferred embodiment, the Central Processing Entity may be in communication with supply chain partners, U.S. customers, and foreign customers, and may receive and share information from each of these entities.

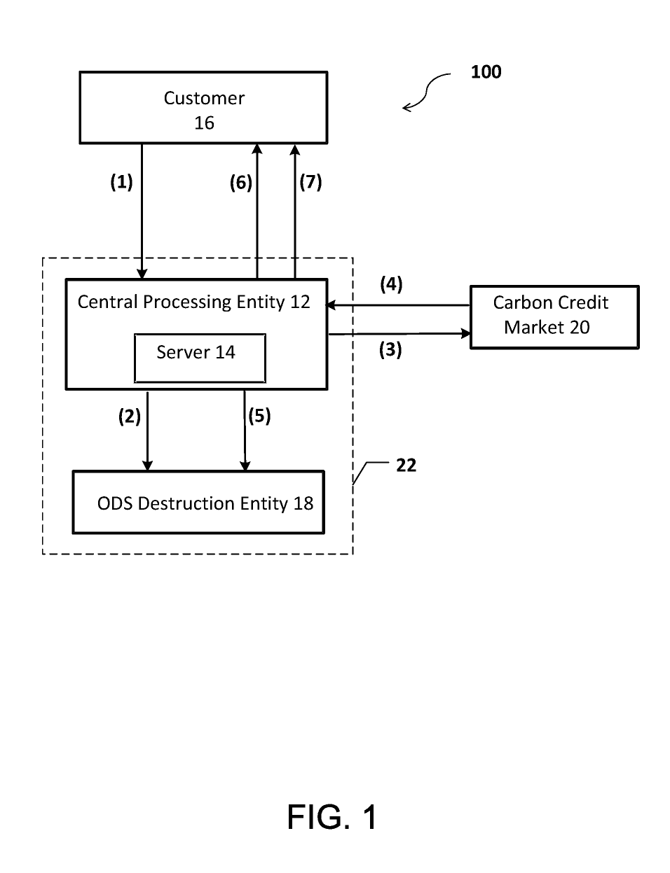

FIG. 1 illustrates the components of a CFC management system 100, according to a preferred embodiment. A Central Processing Entity 12 operates a central command server 14 for the CFC management system. The Central Processing Entity directly transacts with a Customer 16, an ODS Destruction Entity 18, and the Carbon Credit Market 20. The Central Processing Entity 12 and the ODS Destruction Entity 18 may be separate companies or entities, or optionally may be part of the same entity 22

The process steps involved in the CFC management system 10 are also shown in FIG. 1, according to one embodiment. In step (1), the Customer 16 may provide the Central Processing Entity 12 with the ODS (e.g., CFCs) it owns or uses. The Customer 16 can provide ODS directly to the ODS Destruction Entity 18 and provide information regarding the ODS to the Central Processing Entity 12. Alternatively, the Customer 16 may provide the ODS and information regarding the ODS to the Central Processing Entity 12. This step may be taken, for example, pursuant to an outputs contract between the Customer 16 and the Central Processing Entity 12. In step (2), the Central Processing Entity 12 may provide the ODS Destruction Entity 18 with all of its acquired CFCs and payment to process and destroy the CFCs. In step (3), the Central Processing Entity 12 may provide generated carbon credits from CFC destruction by the ODS Destruction Entity 18 to the Carbon Credit Market 20. In step (4), the Central Processing Entity 12 may receive payment for the sale of carbon credits in the Carbon Credit Market 20. In step (5) the ODS Destruction Entity 18 may receive a percentage of the revenue from the sale of carbon credits from the Central Processing Entity 12, or the Central Processing Entity 12 may pay a fixed fee to the ODS Destruction Entity 18 for CFC destruction. In step (6), the Customer 16 may also receive a percentage of the revenue from the sale of carbon credits from the Central Processing Entity 12. In step (7), the Central Processing Entity 12, by the central command server 14, may compute the environmental impact metrics on the pounds of CFCs that are no longer used by the Customer 16 by virtue of the completed transaction, and the central command server 14 may provide this information to the Customer 16.

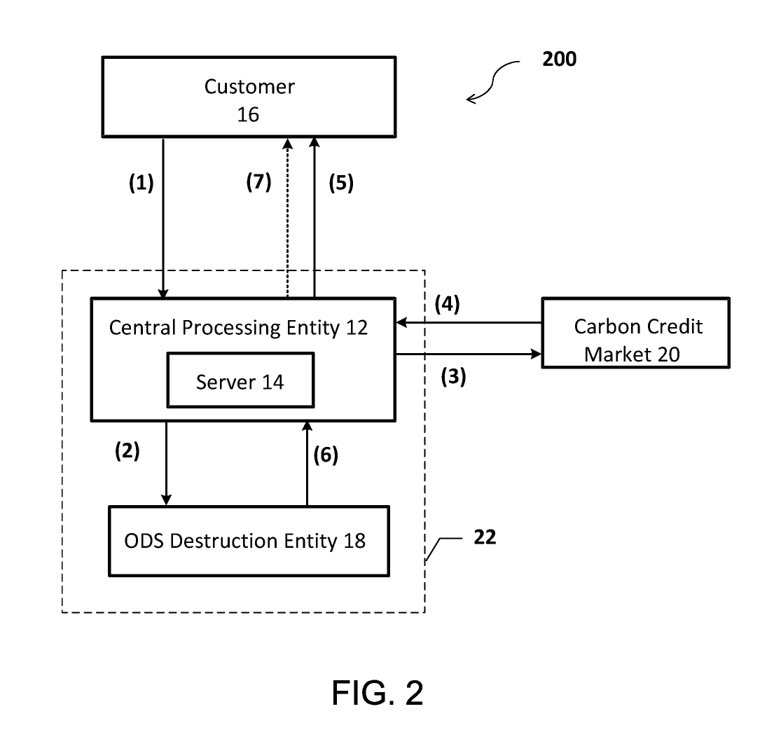

FIG. 2 illustrates the components of a CFC management system 200 according to an alternative embodiment. As in the system described above with reference to FIG. 1, a Central Processing Entity 12 manages ODS logistics and processing to generate carbon credits through operation of the central command server 14. The Central Processing Entity directly transacts with the. Customer 16, the ODS Destruction Entity 18, and the Carbon Credit Market 20. In step (1), the Customer 16 may provide the Central Processing Entity 12 with the CFCs it owns or uses. This step may be taken, for example, pursuant to an outputs contract between the Customer 16 and the Central Processing Entity 12. In step (2), the Central Processing Entity 12 may provide the ODS Destruction Entity 18 with all of its acquired CFCs and payment to process and destroy the CFCs. In step (3), the Central Processing Entity may provide a first portion of the carbon credits generated from by the processing done by the ODS Destruction Entity 18 to the Carbon Credit Market 20. In step (4), the Central Processing Entity 12 may receive payment for the first portion of the carbon credits from sale in the Carbon Credit Market 20. In step (5), the Customer 16 may receive from the Central Processing Entity 12 the second portion of the carbon credits generated by the ODS Destruction Entity 12. In step (6), the ODS Destruction Entity 18 may receive a percentage of the revenue from the sale of carbon credits from the Central Processing Entity 12. Optionally, in step (7) the Customer 16 may also receive a portion of the payment from the Central Processing Entity 12 for the sale of the first portion of carbon credits. Thus, in this embodiment the Customer 16 receives at least part of its compensation in carbon credits instead of money.

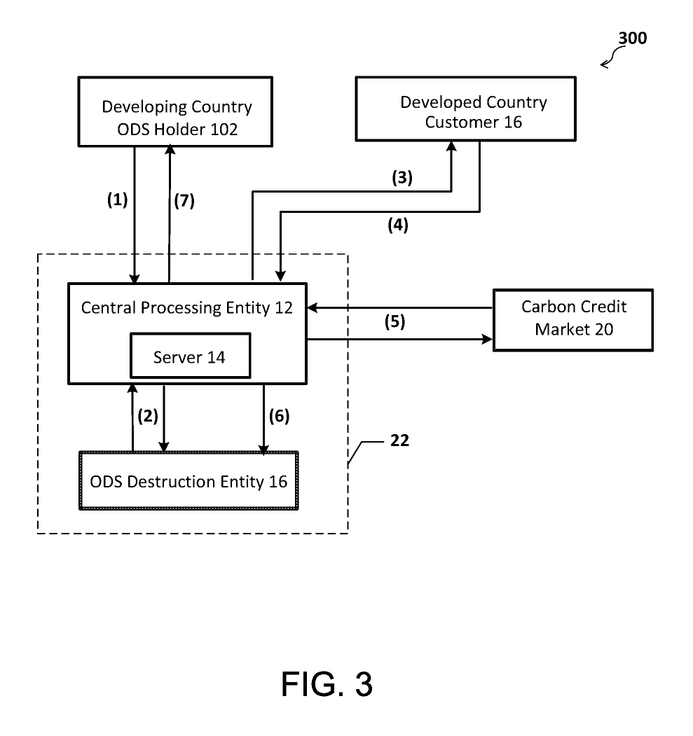

FIG. 3 illustrates the components of a CFC management system 30 according to an alternative embodiment that incorporates trading with developing countries for which the quantification of environmental impact is different compared to that of developed countries, as per the Montreal Protocol.

Developing countries, as designed by Article 5 of the Montreal Protocol, are generally referred to herein as “Developing country ODS holders,” which this is not intended to limit the scope of the claims to any specifically implemented carbon exchange platform, or to limit the scope of the claims to any one set of criteria for developing countries.

As in systems 100 and 200 described above with reference to FIGS. 1 and 2, a Central Processing Entity 12 manages emissions offsets to generate carbon credits through operation of the central command server 14. In this CFC management system 30, the Central Processing Entity 12 mediates carbon credit transactions between Developing country CFC holder 102, Developed country (e.g., U.S.) Customer 16, ODS Destruction Entity 18, and Carbon Credit Market 20.

In step (1), the Developing country CFC holder 102 may provide the Central Processing Entity 12 with the CFCs it owns or uses. This step may be taken, for example, pursuant to an outputs contract between the Developing country CFC holder 102 and the Central Processing Entity 12. In step (2), the Central Processing Entity 12 may provide the ODS Destruction Entity 18 with all of its acquired Article 5 CFC along with payment for processing and destruction. Alternatively, the Developing country CFC holder 102 may provide its acquired Article 5 CFC to the ODS Destruction Entity 18 and provide payment and information about the Article 5 CFC to the Central Processing Entity 12. In step (3), the Central Processing Entity 12 may provide Article 5 carbon credits generated by the CFC destruction to the U.S. Customer 16, and the U.S. Customer 16 in step (4) may provide the Central Processing Entity 12 with the CFCs it owns or uses. This step may be taken, for example, pursuant to an outputs contract between the U.S. Customer 16 and the Central Processing Entity 12. In step (5), the Central Processing Entity may sell the U.S. carbon credits on the Carbon Credit Market 20, receiving payment from the Carbon Credit Market 20 in return. In step (6), the ODS Destruction Entity 18 may receive a percentage of the revenue received by the Central Processing Entity 12 for selling the U.S. carbon credits in step (5). The Central Processing Entity 12 may provide the U.S. CFCs received from the U.S. Customer 16 to the ODS Destruction Entity 18 along with the Article 5 CFCs in step (2). In step (7), the Central Processing Entity 18 pays the Developing country CFC holder 102 a certain amount-per-ton for Article 5 carbon credits generated.

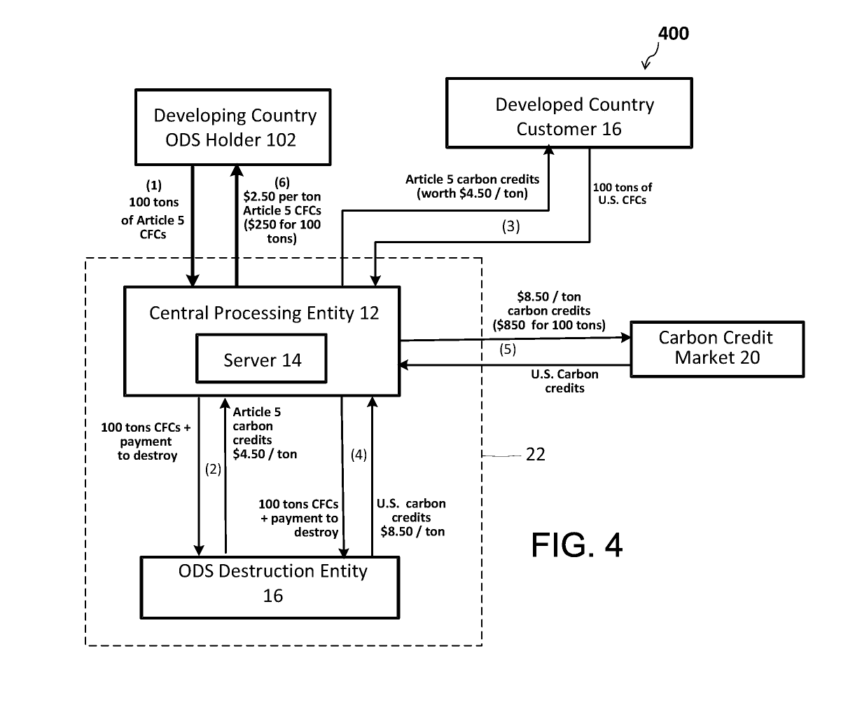

FIG. 4 illustrates an example transaction 400 using CFC management system 300. For the purpose of providing an example, and without any limitation to the scope of the present application, at the time of the example transaction 40 the value of Article 5 carbon credits is $4.50 per ton, and the value of U.S. carbon credits is $8.50 per ton. These numbers are not meant to reflect the actual value of carbon credits at any point in time, but merely are used to enable this example. In step (1), the Developing country ODS holder 102 transfers 100 tons of CFCs it owns or uses to the Central Processing Entity 12 or to the ODS Destruction Entity 18. In step (2), the Central Processing Entity 12 transfers the 100 tons of Article 5 CFCs to the ODS Destruction Entity 18, along with payment for their destruction. In turn the ODS Destruction Entity 18 destroys the 100 tons of Article 5 CFCs to generate 100 tons-equivalent of Article 5 carbon credits, and the Article 5 carbon credits are transferred back to the Central Processing Entity 12. In step (3) the Central Processing Entity 12 transfers the 100 tons-equivalent of Article 5 carbon credits generated by the CFC destruction to a developed country Customer 16, and in exchange the Central Processing Entity 12 receives 100 tons of U.S. CFCs. In step (4), as was done with the Article 5 CFCs in step (2), the Central Processing Entity transfers the 100 tons of U.S. CFCs to the ODS Destruction Entity 18 along with payment to destroy. In turn the ODS Destruction Entity 18 destroys the 100 tons of U.S. CFCs to generate 100 tons-equivalent of U.S. carbon credits. The U.S. carbon credits, which are worth $8.50 per ton, are transferred back to the Central Processing Entity 12. In step (5), the U.S. carbon credits are sold on the carbon credit market for a total of $850, part of which is re-supplied to the ODS Destruction Entity 18 as the payment to destroy the U.S. CFCs in step (4). Further, from the $850 received in the sale of the 100 tons of U.S. carbon credits, in step (6) a portion is paid to the Developing country CFC holder 102 (for example, $250). Thus, the use of the CFC stewardship system is seen to benefit each of the parties that transact through the Central Processing Entity 12 in this example transaction: The Developing country CFC holder 102 is able to get rid of harmful CFCs and earn revenue from the transaction. The U.S. Customer 16 is also able to get rid of harmful CFCs and receive a payment in Article 5 carbon credits at an equivalent weight. The ODS Destruction Entity 18 provides its regular business service of CFC destruction in return for monetary payment. The Central Processing Entity keeps $600, minus what the Central Processing Entity 12 paid to the ODS Destruction Entity 18. Optionally, the Central Processing Entity 12 may pay part of the $600 to the Developing country Customer 102.

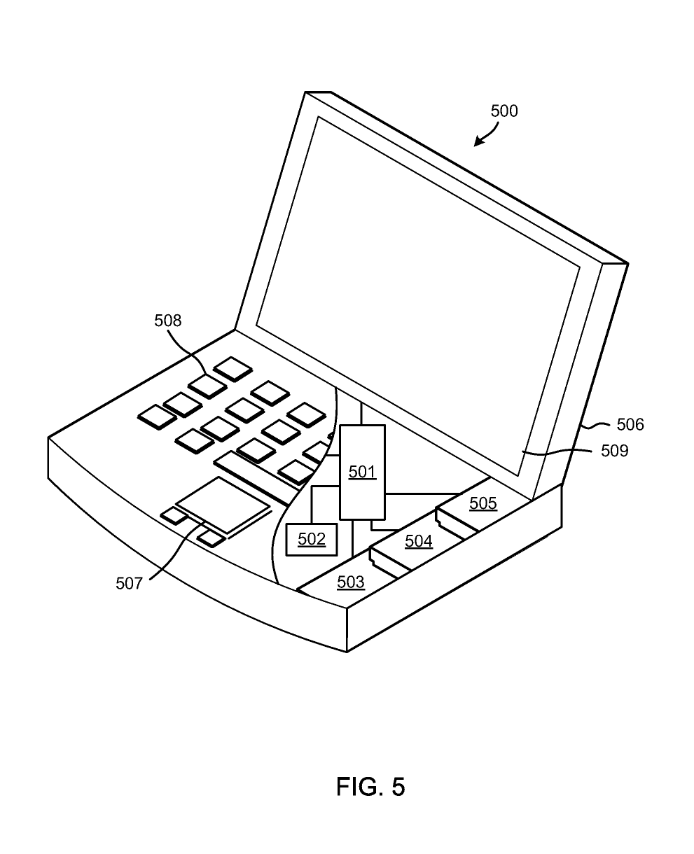

The embodiments described above may be implemented with any of a variety of computing devices, such as a notebook computer 500 illustrated in FIG. 5. Such a notebook computer 500 typically includes a housing 506 that contains a processor 501 coupled to volatile memory 502 and to a large capacity nonvolatile memory, such as a disk drive 503. The computer 500 may also include a floppy disc drive 504 and a compact disc (CD) drive 505 coupled to the processor 501. The computer housing 506 typically also includes a touchpad 507, keyboard 508, and the display 509. In alternative embodiments, the computing device may be any of a variety of mobile devices, including but not limited to a smartphone, a tablet, a personal digital assistant (PDA), etc.

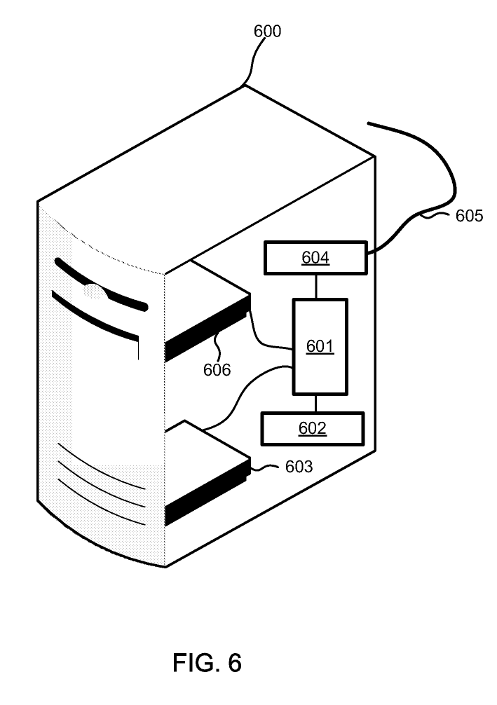

The embodiments described above may also be implemented with any of a variety of remote server devices, such as the server 600 illustrated in FIG. 6. Such a server 600 typically includes a processor 601 coupled to volatile memory 602 and a large capacity nonvolatile memory, such as a disk drive 603. The server 600 may also include a floppy disc drive and/or a compact disc (CD) drive 606 coupled to the processor 601. The server 600 may also include a number of connector ports 604 coupled to the processor 601 for establishing data connections with network circuits 605.

The computing device processor 501, 601 may be any programmable microprocessor, microcomputer or multiple processor chip or chips that can be configured by software instructions (applications) to perform a variety of functions, including the functions of the various embodiments described above. In some Central Processing Entities, multiple processors 501, 601 may be provided, such as one processor dedicated to wireless communication functions and one processor dedicated to running other applications. The processor may also be included as part of a communication chipset.

The various embodiments may be implemented by a computer processor 501, 601 executing software instructions configured to implement one or more of the described methods or processes. Such software instructions may be stored in memory 505, 602, in hard disc memory 503, on tangible storage medium or on servers accessible via a network (not shown) as separate applications, or as compiled software implementing an embodiment method or process. Further, the software instructions may be stored on any form of tangible processor-readable memory, including: a random access memory 505, 602, hard disc memory 503, a floppy disk (readable in a floppy disc drive 504), a compact disc (readable in a CD drive 505), electrically erasable/programmable read only memory (EEPROM), read only memory (such as FLASH memory), and/or a memory module (not shown) plugged into a central command server 14 such as an external memory chip or USB-connectable external memory (e.g., a “flash drive”) plugged into a USB network port. For the purposes of this description, the term memory refers to all memory accessible by the processor 501, 601 including memory within the processor 501, 601 itself.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the steps as a sequential process, many of the steps can be performed in parallel or concurrently.

Any reference to claim elements in the singular, for example, using the articles “a,” “an” or “the” is not to be construed as limiting the element to the singular.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

1. A method for managing destruction of an ozone-depleting or halogenated substance, comprising:
providing the ozone-depleting or halogenated substance from a plurality of customers to a destruction process, wherein the destruction of the substance creates carbon credits;
selling at least a first portion of the carbon credits on a carbon credit market;
receiving proceeds from the sale of the carbon credits; and
sharing the proceeds from the sale of the carbon credits with at least one participant in the destruction process,
wherein the value of carbon credits per unit of the ozone-depleting or halogenated substance destroyed from different customers of the plurality of customers have different values per unit of the substance destroyed.

2. The method of claim 1, further comprising verifying a result from the destruction process.

3. The method of claim 1, further comprising verifying the destruction process for compliance with standards maintained by the carbon credit market.

4. The method of claim 1, wherein the ozone-depleting or halogenated substance comprises a man-made halogenated ozone-depleting substance (ODS).

5. The method of claim 1, wherein the ozone-depleting or halogenated substance is selected from the group consisting of chlorofluorocarbons (CFCs), hydrochlorofluorocarbons (HCFCs), and hydro fluorocarbons (HFCs).

6. The method of claim 1, wherein:
at least a first customer of the plurality of customers is a developing country customer;
at least a second customer of the plurality of customers is a developed country customer;
the value per unit of ozone-depleting or halogenated substance destroyed from the developed country customer is greater than the value per unit of ozone-depleting or halogenated substance destroyed from the developing country customer;
the first portion of the carbon credits comprises the carbon credits created by destruction of the ozone-depleting or halogenated substance from the developed country customer;
at least a portion of the proceeds from sale of the first portion of the carbon credits is provided to the developing country customer; and
at least a portion of the carbon credits created by destruction of the ozone-depleting or halogenated substance from the developing country customer are provided to the developed country customer.

7. The method of claim 1, further comprising providing a second portion of the carbon credits to the at least one customer.

8. The method of claim 1, wherein sharing the proceeds from the sale of the carbon credits with the at least one participant in the destruction process increases the value of the oxygen-depleting or halogenated substance to the at least one participant.

9. The method of claim 1, wherein the carbon credit market comprises a carbon credit exchange.

10. The method of claim 1, further comprising sharing the proceeds from the sale of the carbon credits with entities in a supply chain, wherein the value of the ozone-depleting or halogenated substance to the entities in the supply chain is increased.

11. A management system for an ozone-depleting or halogenated substance, comprising:
a central processing entity;
at least one customer; and
a processing entity;
wherein the central processing entity communicates with the at least one customer and the processing entity to perform steps comprising:
receiving an ozone-depleting or halogenated substance from a plurality of customers;
providing the ozone-depleting or halogenated substance to a destruction process, wherein the destruction of the ozone-depleting or halogenated substance creates carbon credits;
selling a first portion of the carbon credits on a carbon credit market;
receiving proceeds from the sale of the carbon credits; and
sharing the proceeds from the sale of the carbon credits with a destruction entity,
wherein the ozone-depleting or halogenated substance received from the plurality of customers has different destruction values based on the customer, wherein the different destruction values are expressed as different values of the carbon credits created.

12. The management system of claim 11, wherein the central processing entity communicates with the at least one customer and the destruction entity to perform steps further comprising verifying a result from the destruction process.

13. The management system of claim 11, wherein the central processing entity communicates with the at least one customer and the destruction entity to perform steps further comprising verifying the destruction process for compliance with standards maintained by the carbon credit market.

14. The management system of claim 11, wherein the ozone-depleting or halogenated substance comprises a man-made halogenated ozone-depleting substance (ODS).

15. The management system of claim 11, wherein the ozone-depleting or halogenated substance is selected from the group consisting of chlorofluorocarbons (CFCs), hydrochlorofluorocarbons (HCFCs), and hydrofluorocarbons (HFCs).

16. The management system of claim 11, wherein:
at least a first customer of the plurality of customers is a developing country customer;
at least a second customer of the plurality of customers is a developed country customer;
the value per unit of ozone-depleting or halogenated substance destroyed from the developed country customer is greater than the value per unit of ozone-depleting or halogenated substance destroyed from the developing country customer;
the first portion of the carbon credits comprises the carbon credits created by destruction of the ozone-depleting or halogenated substance from the developed country customer;
at least a portion of the proceeds from sale of the first portion of the carbon credits is provided to the developing country customer; and
at least a portion of the carbon credits created by destruction of the ozone-depleting or halogenated substance from the developing country customer are provided to the developed country customer.

17. The management system of claim 11, wherein the central processing entity communicates with the at least one customer and the processing entity to perform steps further comprising providing a second portion of the carbon credits to the at least one customer.

18. The management system of claim 11, wherein the central processing entity communicates with the at least one customer and the processing entity to perform steps further comprising sharing the proceeds from the sale of the carbon credits with the at least one customer.

19. The management system of claim 11, wherein the carbon credit market comprises a carbon credit exchange.

20. The management system of claim 11, further comprising sharing the proceeds from the sale of the carbon credits with entities in a supply chain.

21. The management system of claim 11, wherein the processing entity is a destruction entity.

22. The management system of claim 11, wherein the creation of carbon credits from the destruction process prevents the ozone-depleting or halogenated substance from causing emission of greenhouse gases (GHGs).
